(19) United States
(12) Patent Application Publication
(10) Pub. No.: US 2011/0274928 A1
(43) Pub. Date: Nov. 10, 2011

(54) MAGNETIC NANOSTRUCTURES

(75) Inventor: Feng LIU, Salt Lake City, UT (US)

(73) Assignee: UNIVERSITY OF UTAH

(21) Appl. No.: 12/965,265

(22) Filed: Dec. 10, 2010

Related U.S. Application Data
(60) Provisional application No. 61/285,735, filed on Dec. 11, 2009.

(51) Int. Cl. B32B 3/00; B82Y 99/00

(52) U.S. Cl. 428/402; 977/774

(57) ABSTRACT

A magnetic material is disclosed including magnetic nanostructures such as nanodots or nanoribbons. The long range magnetic ordering of the material may depend on one or more structural characteristics of the nano structures.

### CROSS REFERENCE TO RELATED APPLICATIONS

This claims benefit of U.S. Provisional Application Ser. No. 61/285,735 filed Dec. 11, 2009. The entire contents of which are incorporated by reference herein.

### STATEMENT OF GOVERNMENT RIGHTS

This invention was made with government support under DE-FG02-03ER46148 and DE-FG02-04ER 46027 awarded by Department of Energy. The Government has certain rights to this invention.

### BACKGROUND

This disclosure is related to magnetic and semiconductor materials, e.g., magnetic material for information storage media, semiconductors for information processing, etc.

Magnetic materials have a wide range of applications, such as being used for storage media. Magnetism is commonly associated with elements containing localized d or f electrons, i.e. the itinerant ferromagnetism. In contrast, the elements containing diffuse sp electrons are intrinsically non-magnetic, but magnetism can be induced in sp-element materials extrinsically by defects and impurities. There have been continuing efforts in searching for new magnetic materials, and much recent interest has been devoted to magnetism of carbon-based, especially graphene-based structures such as graphene nanoribbons and nanoflakes.

Graphene nanoribbons and nanoflakes with “zigzag” edges have been shown to exhibit magnetism. Their magnetization is originated from the localized edge states that give rise to a high density of states at the Fermi level rendering a spin-polarization instability.

### SUMMARY OF THE INVENTION

The inventors have realized that magnetic materials may be formed using nanostructures such as superlattices of graphene nanoholes (NHs) (e.g. array of nano-sized holes patterned in a graphene sheet or one or more layers of graphite). Unlike nanoribbons and nanoflakes, the GNH superlattices constitute a family of 2D crystalline “bulk” magnets whose collective magnetic behavior is governed by inter-NH spin-spin interaction in addition to spin coupling within one single NH. They allow long-range magnetic order well above room temperature. The magnetic properties (e.g. the critical temperature for long-range magnetic ordering) of the material depend on the structural properties of the NH lattice (e.g. NH size/shape, NH lattice type/spacing/density, etc.). Accordingly, such magnetic properties can be “tuned” by suitable choice of NH superlattice structure.

The inventors have also realized that semiconductor materials may similarly be formed using NH superlattices. In this case, the electrical properties (e.g. the semiconductor bandgap) of the material depend on the structural properties of the NH lattice. Accordingly, the semiconductor material properties can be “tuned” by suitable choice of NH superlattice structure.

Furthermore, magnetic semiconductors, such as diluted magnetic semiconductors (DMSs) can be formed using a combination of types of nanostructures. For example, as described in detail below, a DMS can be produced by doping, e.g., triangular zigzag NHs into a semiconducting superlattice of, e.g., rhombus armchair NHs.

Such materials offer a new system for fundamental studies of spin-spin interaction and long-range magnetic ordering in low dimensions, and open up the exciting opportunities of making engineered magnetic and/or semiconducting materials with NHs for magnetic storage media, spintronics applications, sensor and detector applications, etc.

A magnetic material is disclosed including: a two-dimensional array of carbon atoms; and a two-dimensional array of nanoholes patterned in the two-dimensional array of carbon atoms. The magnetic material has long-range magnetic ordering at a temperature below a critical temperature Tc.

In some embodiments, Tc is greater than 298° K. In some embodiments, Tc depends on a structural property of the two-dimensional array of nanoholes.

In some embodiments, the two-dimensional array of carbon atoms consists of an open hexagonal array, or an array with any other type of symmetry. In some embodiments, the two-dimensional array of nanoholes includes an array of nanoholes with edges having a zigzag configuration.

In some embodiments, the long-range magnetic ordering is ferromagnetic ordering. In some embodiments, the long-range magnetic ordering is anti-ferromagnetic ordering.

In some embodiments, the two-dimensional array of nanoholes includes a first sublattice of nanoholes and a second sublattice of nanoholes. In some embodiments, the nanoholes of the first sublattice are arranged in a parallel configuration with respect to the nanoholes of the second sublattice. In some embodiments, the nanoholes of the first sublattice are arranged in an anti-parallel configuration with respect to the nanoholes of the second sublattice.

In some embodiments, the array of nanoholes includes at least one from the group of: a triangular shaped nanohole, a rhombus shaped nanohole, and a hexagonal nanohole.

In some embodiments, the array of nanoholes includes a nanohole having a characteristic size of about 50 nm or less, of about 100 nm or less, of about 500 nm or less, of about 1000 nm or less, or of about 5000 nm or less.

In some embodiments, the array of nanoholes has a density greater than about 10̂-4 nanoholes per nm². In some embodiments, the array of nanoholes has a density within the range of about 10̂-8 nanoholes per nm² to about 10̂-2 nanoholes per nm².

In another aspect, a semiconductor material is disclosed including: a two-dimensional array of carbon atoms; and a two-dimensional array of nanoholes patterned in the two-dimensional array of carbon atoms. The semiconductor material has a semiconductor bandgap Δ. In some embodiments, the bandgap Δ depends on a structural property of the two-dimensional array of nanoholes.

In some embodiments, the two-dimensional array of carbon atoms consists of an open hexagonal array, or an array with any other type of symmetry. In some embodiments, the two-dimensional array of nanoholes includes an array of nanoholes with edges having an armchair configuration.

In some embodiments, wherein the array of nanoholes consists of an array of triangular or rhombus shaped nanoholes.

In some embodiments, 1 meV≦Δ≦20 meV. In some embodiments, 1 meV≦Δ≦2 eV.

In another aspect, a diluted magnetic semiconductor is disclosed including: a two-dimensional array of carbon atoms; a two-dimensional array of a first type of nanoholes patterned in the two-dimensional array of carbon atoms; and a two-dimensional array of a second type of nanoholes patterned in the two-dimensional array of carbon atoms. The diluted magnetic semiconductor material has a semiconductor bandgap Δ. The diluted magnetic semiconductor has long-range magnetic ordering at a temperature below a critical temperature Tc. In some embodiments, Tc is greater than 298° K.

In some embodiments, the two-dimensional array of the first type of nanoholes consists of nanoholes having intra-nanohole magnetic ordering. In some embodiments, Tc depends on a structural property of the two-dimensional array of the first type of nanoholes. In some embodiments, the bandgap Δ depends on a structural property of the two-dimensional array of the second type of nanoholes.

In some embodiments, wherein the two-dimensional array of carbon atoms consists of an open hexagonal array, or an array having any other type of symmetry.

In some embodiments, the two-dimensional array of the first type nanoholes includes an array of nanoholes each with edges having a zigzag configuration. In some embodiments, the two-dimensional array of the second type nanoholes includes an array of nanoholes each with edges having an armchair configuration.

In some embodiments, the long-range magnetic ordering is ferromagnetic ordering. In some embodiments, the long-range magnetic ordering is anti ferromagnetic ordering.

In some embodiments, the array of the second type of nanoholes consists of an array of rhombus shaped or hexagonal shaped nanoholes.

In some embodiments, 1 meV≦Δ≦20 meV. In some embodiments, 500 meV≦Δ≦2000 meV.

In another aspect, a magnetic information storage media is disclosed including: a two-dimensional array of carbon atoms, the array including a plurality of magnetic nanostructures, each of the nanostructures being in one of least two available magnetic states. The at least two available magnetic states include a first magnetic state associated with a first memory state; and a second magnetic state associated with a second memory state.

In some embodiments, the plurality of magnetic nanostructures includes a plurality of nanoholes.

In some embodiments, for each of the plurality of nanoholes, the first magnetic state is a state of intra-nanohole antiferromagnetic ordering and the second magnetic state is a state of intra-nanohole ferromagnetic ordering.

Some embodiments include a reader unit adapted to read out the magnetic state of one or more of the plurality of magnetic nanostructures. Some embodiments include a write unit adapted to change the magnetic state of one or more of the plurality of magnetic nanostructures.

In some embodiments, the plurality of nanoholes includes a nanohole having a characteristic size of about 50 nm or less. In some embodiments, the plurality of nanoholes includes a nanohole having a characteristic size in the range of about 50 nm to about 1000 nm. In some embodiments, the plurality of nanoholes has an average density greater than about 10̂-4 nanoholes per nm².

In some embodiments, the first and second magnetic states are stable over a timescale greater than 1 hour.

In another aspect, an apparatus is disclosed including a detector including: a semiconductor material which includes a two-dimensional array of carbon atoms; and a two-dimensional array of nanoholes patterned in the two-dimensional array of carbon atoms, wherein the semiconductor material has a semiconductor bandgap Δ, and wherein the detector is adapted to produce a signal in response to electromagnetic radiation incident on the semiconductor material.

In some embodiments, the bandgap Δ depends on a structural property of the two-dimensional array of nanoholes.

In some embodiments, the detector is adapted to produce a signal in response to electromagnetic radiation incident on the semiconductor material, the radiation having a frequency corresponding to a photon energy at or near the bandgap Δ.

In some embodiments, 1 meV≦Δ≦20 meV, and the detector is adapted to produce a signal in response to electromagnetic radiation incident on the semiconductor material, the radiation having a frequency in the terahertz or far infrared radiation.

In another aspect a magnetic material is disclosed including: a plurality of layers, each including a two-dimensional array of carbon atoms; and a two-dimensional array of nanoholes patterned in at least one of the two-dimensional array of carbon atoms. The magnetic material has long-range magnetic ordering at a temperature below a critical temperature Tc. In some embodiments, Tc is greater than 298° K.

In some embodiments, wherein Tc depends on a structural property of the two-dimensional array of nanoholes.

In some embodiments, the plurality of layers includes a top layer and one or more underlying layers, and the two-dimensional array of nanoholes is patterned in the top layer.

In some embodiments, the two-dimensional array of nanoholes includes an array of nanoholes with edges having a zigzag configuration.

In some embodiments, the one or more underlying layers include bulk carbon, e.g. a highly oriented pyrolytic graphite film.

In another aspect, a magnetic material is disclosed including: a plurality of layers stacked along a vertical direction, each layer including a two-dimensional array of carbon atoms; and a two-dimensional array of nanotunnels patterned substantially vertically through the plurality of layers. The magnetic material has long-range magnetic ordering at a temperature below a critical temperature Tc. In some embodiments, Tc is greater than 298° K.

In some embodiments, Tc depends on a structural property of the two-dimensional array of nanotunnels. In some embodiments, wherein the two-dimensional array of nanoholes includes an array of nanotunnels with edges having a zigzag configuration In some embodiments, the plurality of layers includes bulk carbon, e,g, a highly oriented pyrolytic graphite film.

In another aspect, an apparatus is disclosed including a detector material which includes a two-dimensional array of carbon atoms and a two-dimensional array of nanoholes patterned in the two-dimensional array of carbon atoms. The apparatus also includes a monitor which produces a signal indicative of a change in a physical property of the material in response to a change in a chemical environment of the detector material. In some embodiments, the monitor produces a signal indicative of a change in a transport property of the detector material in response to adsorption of molecules from the chemical environment by the two-dimensional array of nanoholes.

In one aspect, a magnetic material is disclosed including a graphene nanodot. The nanodot includes a two dimensional bipartite lattice of carbon atoms, which includes a first sublattice of carbon atoms having a first spin state and a second sublattice of carbon atoms having a second spin state.

In some embodiments, the graphene nanodot includes a ferromagnetic nanodot, where the each of the edges of the nanodot are oriented at 0 or 120 degrees with respect to any neighboring edge, and where each edge carbon atom has the same spin state. In some embodiments, the nanodot includes a triangular nanodot.

In some embodiments, the ferromagnetic nanodot includes N total atoms, is arranged in a maximally elongated structure available for a ferromagnetic nanodot having N atoms arranged such that each of the edges of the nanodot are oriented at 0 or 120 degrees with respect to any neighboring edge. In some embodiments, the nanodot includes three triangular portions sharing a common edge. In some embodiments, the nanodot includes three triangular portions sharing a common corner

In some embodiments, the graphene nanodot includes an anti-ferromagnetic nanodot, where the each of the edges of the nanodot are oriented at 60 or 180 degrees with respect to any neighboring edge, and where each and every edge carbon atom has the same spin orientation. In some embodiments, the nanodot includes a hexagonal nanodot.

In some embodiments, the magnetic material has long-range magnetic ordering at a temperature below a critical temperature Tc. In some embodiments, Tc is greater than 298° K. In some embodiments, the long range ordering is ferromagnetic. In some embodiments, the long range ordering is anti-ferromagnetic.

In some embodiments, the two dimensional bipartite lattice of carbon atoms consists of an hexagonal array of carbon atoms. In some embodiments, the nanodot has edges having a zigzag configuration on the hexagonal array.

In some embodiments, the nanodot has characteristic size of about 50 nm or less, 100 nm or less, 500 nm or less, 1000 nm or less, or 5000 nm or less, etc.

In another aspect, a magnetic material is disclosed including a graphene nanoribbon. The nanoribbon includes a two dimensional bipartite lattice of carbon atoms including a first sublattice of carbon atoms having a first spin state and a second sublattice of carbon atoms having a second spin state. The nanoribbon is elongated along a major dimension and extends between a first edge and a second edge along a minor dimension transverse the major dimension.

In some embodiments, the nanoribbon includes a ferromagnetic nanoribbon. The first edge is included of a plurality of edge portion, where each of the edge portions are oriented at 0 or 120 degrees with respect to any neighboring edge portion. Each edge portion carbon atom has the same spin state. In some embodiments, at least a portion of the first edge has a saw-toothed shape.

In some embodiments, the second edge is included of a plurality of edge portion, where each of the edge portions of the second edge are oriented at 0 or 120 degrees with respect to any neighboring edge portion, and where each edge portion carbon atom has the same spin state.

In some embodiments, at least a portion of both the first and the second edge have a saw-toothed shapes, e.g. to form a “Christmas tree” configuration.

In some embodiments, the magnetic material has long-range magnetic ordering at a temperature below a critical temperature Tc. In some embodiments, Tc is greater than 298° K. In some embodiments, the long range ordering is ferromagnetic. In some embodiments, the long range ordering is anti-ferromagnetic.

In some embodiments, the two dimensional bipartite lattice of carbon atoms consist of an open hexagonal array. In some embodiments, the nanoribbon has edges having a zigzag configuration on the hexagonal array.

In some embodiments, the nanoribbon has characteristic size along the minor dimension of about 50 nm or less, 100 nm or less, 500 nm or less, 1000 nm or less, or 5000 nm or less, etc.

In another aspect, a method of making a magnetic material is disclosed which includes providing at least one array of carbon atoms, determining a desired structure of the material based on the design principles described herein, and patterning the array to form the desired structure. The patterning may be accomplished using any suitable fabrication technique know in the art, e.g., photolithographic techniques, nano-imprint lithographic techniques, etching techniques, etc.

Various embodiments may include any of the above features, elements, techniques, etc., alone or in any suitable combination.

### BRIEF DESCRIPTION OF THE DRAWINGS

FIG. 1a-1c illustrate magnetism in a single GNH. The ground-state magnetic configurations of different shapes of NHs are shown: (a) FM triangular NH; (b) AF rhombus NH; (c) AF hexagonal NH. In (a-c), light and dark balls indicate the up- and down-spin density isosurface at 0.02 e/Å3, respectively; dark and light sticks represent C—C and C—H bonds respectively.

FIG. 1d shows a plot of the average local magnetic moment (μ_{B}) per atom in the triangular NH (FIG. 1a) as a function of distance moving away from the center of NH, measured in atomic shells with the edge atoms as the first shell. The inset shows μ_{B} on the edge vs. NH size (l).

FIG. 2a shows ground-state spin configurations in a FM honeycomb NH superlattice. All the symbols and notations for bonds and spin densities are the same as FIG. 1. Dashed lines mark the primitive cell.

FIG. 2b shows ground-state spin configurations in a AF superlattice. All the symbols and notations for bonds and spin densities are the same as FIG. 1. Dashed lines mark the primitive cell.

FIG. 2c shows a plot of ΔE_{pc}=E(FM)−E(PM) of the FM superlattice of FIG. 2a and ΔE_{ac}=E(AF)−E(PM) of the AF superlattice of FIG. 2b versus cell dimension (L).

FIG. 2d shows a plot of Curie temperature of the FM superlattice in FIG. 2a as a function of NH size (l) and cell dimension (L).

FIG. 3a shows a semiconductor GNH hexagonal lattice (L=8 a, a=2.46 Å is the lattice constant of graphene) of an array of rhombus armchair NHs (l=4 a). All the symbols and notations for bonds and spin densities are the same as FIG. 1.

FIG. 3b shows the band structure of the semiconductor GNH hexagonal lattice of FIG. 3a. The inset shows the Brillouin zone.

FIG. 3c shows the TB band gap of a semiconductor GNH hexagonal lattice of the type shown in FIG. 3a as a function of NH size (l) and cell dimension (L).

FIG. 3d illustrates a magnetic semiconductor made by doping the structure shown in FIG. 3a with triangular zigzag NHs. All the symbols and notations for bonds and spin densities are the same as FIG. 1.

FIG. 4 illustrates a magnetic storage medium consisting of a patterned array of rhombus GNHs. The insets show the detailed structure of “0” and “1” bit, represented by the ground-state AF configuration (S=0) and the excited FM configuration (S=N), respectively. Dark and light balls show the spin-up and spin-down density respectively at an isosurface value of 0.02 e/Å³.

FIG. 5 is a spin-density plot of the ferrimagnetic configuration of a 4-atom triangular NH. Light and dark balls indicate the up- and down-spin density isosurface at 0.02 e/Å³ respectively; dark and light sticks represent C—C and C—H bonds respectively.

FIG. 6 is a schematic illustration of four possible types of Bravais lattice of GNHs that can be patterned in graphene. Solid arrows and lines mark the primitive cells. (a) hexagonal lattice; (b) rectangular lattice; (c) centered rectangular lattice; the dashed lines mark the conventional cell; (d) oblique lattice.

FIG. 7 plots the density of states (DOS) of GNH superlattices. Upper panel: DOS of a FM superlattice containing two parallel NHs (FIG. 3a). Lower panel: DOS of an AF superlattice containing two antiparallel NHs (FIG. 3b). Note the small gap at Fermi energy.

FIG. 8 Is a plot of the total spin (S) within one unit cell of GNH superlattices. Squares show S of FM superlattices containing two parallel NHs (FIG. 3a), and triangles show S of AF superlattices containing two antiparallel NHs (FIG. 3b) as a function of NH size (l).

FIG. 9 Is a plot of Average magnetic moment on the NH edge (μ_{B}) as a function of cell size (L). Squares show μ_{B} in the FM (FIG. 3a) lattices with fixed hole size (l=0.738 nm), and triangles show μ_{B} in the AF (FIG. 3b) lattices with fixed hole size (l=1.476 nm).

FIG. 10 is a schematic of a detector.

FIG. 11 is a schematic of a detector.

FIG. 12a is an illustration of atomic structure of supported nanoholes featuring a 9-atom up-triangular nanohole in a first whose edge atoms each sit on top of an atom in the second layer. Carbon atoms are shown as dark balls in the first layer and light balls in the second layer.

FIG. 12b is an illustration of atomic structure of supported nanoholes featuring 9-atom down-triangular nanohole whose edge atoms sitting above the center of hexagon in the second layer. Carbon atoms are shown as dark balls in the first layer and light balls in the second layer.

FIG. 12c is an illustration of atomic structure of an up-triangular nanochannel with a 9-atom nanohole in the first layer and a 4-atom nanohole in the second layer. Carbon atoms are shown as dark balls in the first layer and light balls in the second layer.

FIG. 12d is an illustration of atomic structure of a down-triangular with a 9-atom nanohole in the first layer and a 16-atom nanohole in the second layer. Carbon atoms are shown as dark balls in the first layer and light balls in the second layer.

FIGS. 13a-f illustrate the FM ground-state magnetic configuration of a 4-atom triangular nanohole in free and supported graphene. Light colored balls indicate the spin density isosurface at 0.03 e/Å3.

FIG. 13a shows a perspective view of the FM ground-state in a free graphene sheet.

FIG. 13b shows a top view of the FM ground-state in a free graphene sheet

FIG. 13c shows a perspective view of the FM ground-state in a graphene sheet supported on one layer.

FIG. 13d shows a top view of the FM ground-state in a graphene sheet supported on one layer.

FIG. 13e shows perspective view of the FM ground-state in a graphene sheet supported on two layers of graphite film.

FIG. 13f shows a top view of the FM ground-state in in a graphene sheet supported on two layers of graphite film.

FIGS. 14a-b show the FM ground-state magnetic configuration of a triangular nanochannel in graphite film consisting of a 9- and 16-atom nanohole in the A and B layer, respectively. Light colored balls indicate the spin density isosurface at 0.03 e/Å3.

FIG. 14a shows a perspective view of the spin density distribution within one supercell.

FIG. 14b shows a top down view of spin density distribution of FIG. 14a looking down through the nanochannel.

FIG. 14c is a plot of the band structure of the nanochannel of FIG. 14a.

FIG. 15 is a schematic illustration of the underlying geometric relationship between zigzag edges in graphene. The figure illustrates that the edges are on the same sublattice A (light grey) or B (dark grey)) if they are at an angle of 0° or 120° to each other, but on different sublattices (A vs B) if at an angle of 60° or 180°.

FIGS. 16a-d illustrate the design of nanodots having a high magnetic moment: (a) a triangular graphene structure; (b) a hexagonal graphene structure; (c) an FM nanodot derived from the triangular structure; (d) an FM nanodot derived from the hexagonal structure.

FIGS. 17a-c show schematics of nanoribbons with different edge configurations: (a) an AF nanoribbon with straight edges; (b) an FM tree-saw nanoribbon; (c) an FM Christmas-tree nanoribbon. The rectangles indicate one unit cell for each ribbon, which show the calculated spin density contour of the ground state magnetic configuration.

FIGS. 18a-b show schematics of the graphene nanohole superlattice: (a) an FM hexagonal NH lattice; (b) an AF hexagonal NH lattice. The rhombuses indicate one unit cell of each superlattice, and show the calculated spin density contour of the ground state magnetic configuration.

### DETAILED DESCRIPTION

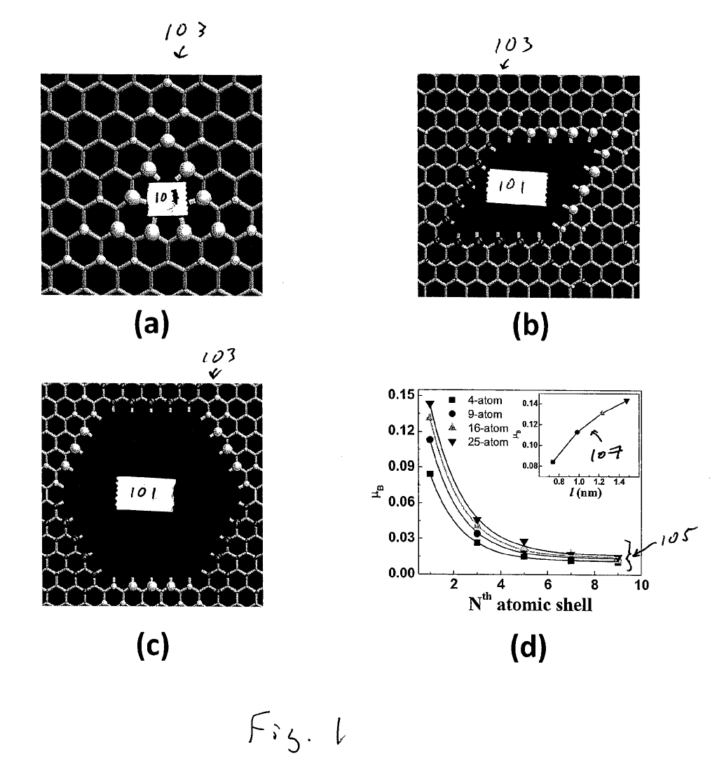

Referring to FIG. 1a through FIG. 1c, in some embodiments, graphene nanoholes 101 (GNHs) made inside a graphene sheet 103 with “zigzag” edges (i.e. edges formed as shown in FIG. 1 in the honeycomb array of the carbon atoms of the graphene sheet), exhibit magnetism. In these Figs., light and dark balls indicate the up- and down-spin density isosurface at 0.02 e/Å3, respectively; dark and light sticks represent C—C and C—H bonds respectively.

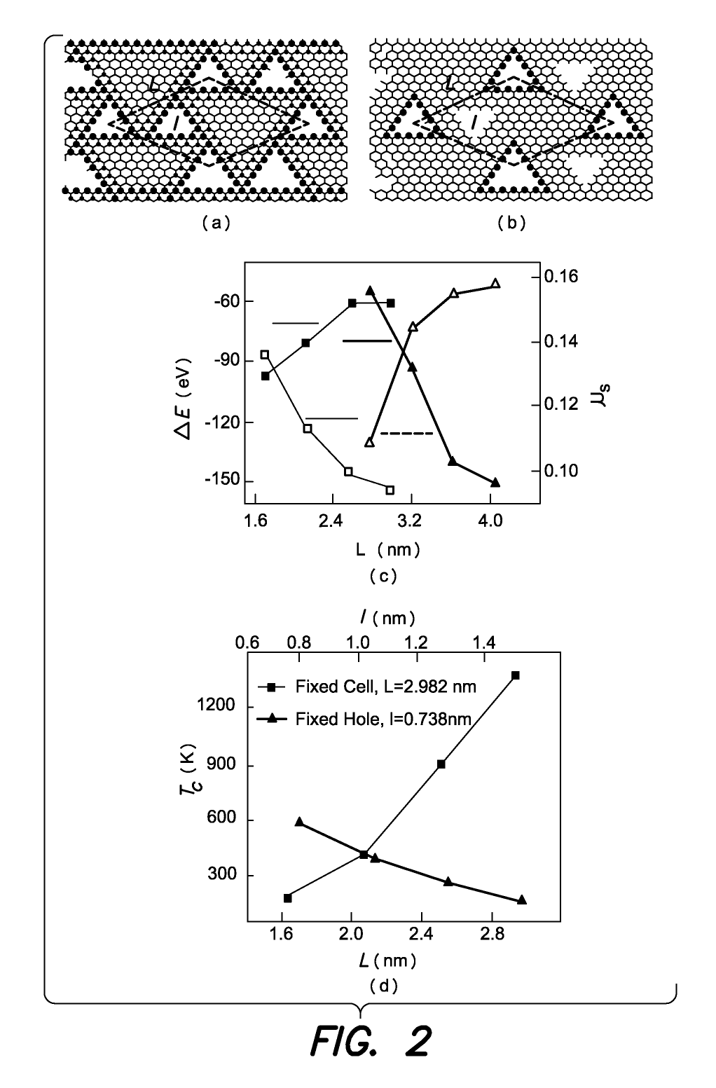

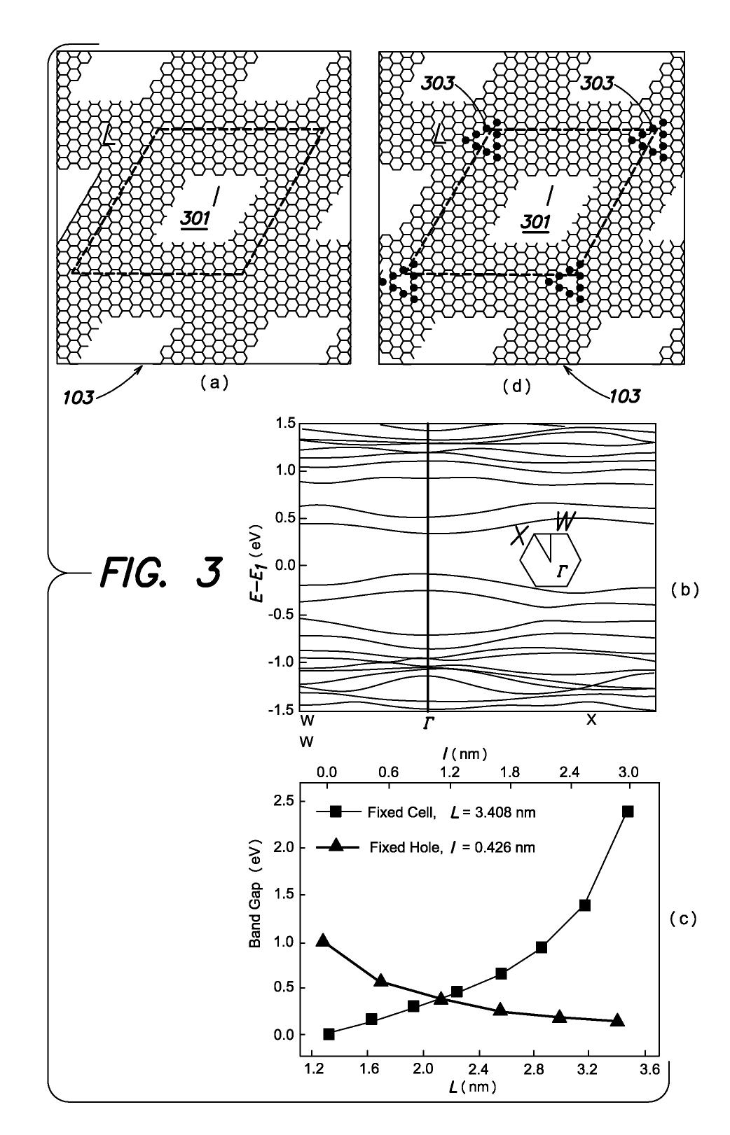

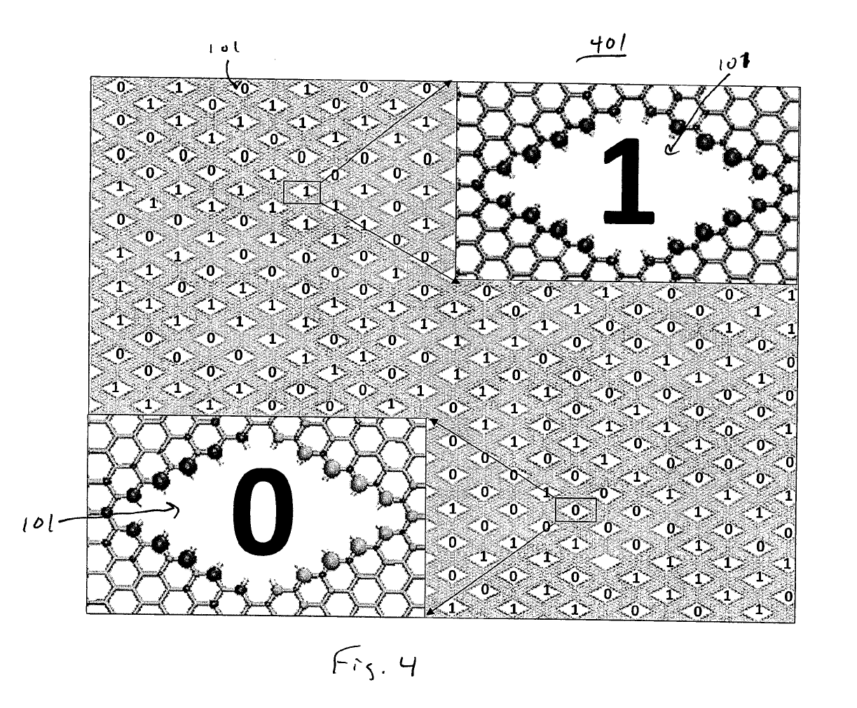

As described below, an array of such NHs, e.g. as shown in FIGS. 2a and 2b can exhibit collective “bulk” magnetism because inter-NH spin-spin interactions are introduced in addition to the intra-NH spin coupling. Such intra-NH coupling may provide long-range (i.e., over multiple sites in the NH lattice) magnetic ordering (e.g., ferromagnetic or antiferromagnetic ordering). This allows the formation of materials that take advantage of spins within more than just a single nanoribbon or nanoflake. For example, in various embodiments, superlattices composed of a periodic array of NH spins form nanostructured magnetic 2D crystals with the NH acting like a “super” magnetic atom.

Although not intending to be bound by theory, the magnetic properties of GNHs have been studied using first-principles calculations. Considering first a single zigzag NH by examining the intra-NH spin-spin interaction, we found that individual NH can be viewed as an “inverse structure” of nanoflake or nanoribbon, like an anti-flake or anti-ribbon, with similar spin behavior. We determine the ground-state magnetism of three typical NH shapes: triangular (FIG. 1a), rhombus (FIG. 1b) and hexagonal (FIG. 1c), by comparing the relative stability of ferromagnetic (FM), antiferromagnetic (AF) and paramagnetic (PM) configuration as a function of NH size. Our calculations show that the ground state is FM for triangular NHs, but AF for rhombus and hexagonal NHs, and their spin densities are shown in FIGS. 1a, 1b and 1c, respectively. As shown in FIG. 1d the magnetic moments 105 are highly concentrated on the edges and decay quickly away from the edge. Similar decaying behavior has been seen in nanoribbons and nanoflakes. The edge moment 1-7 increases with increasing NH size (FIG. 1d, inset).

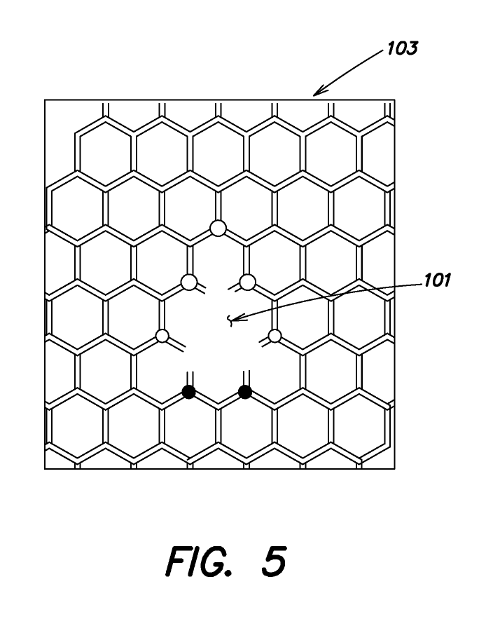

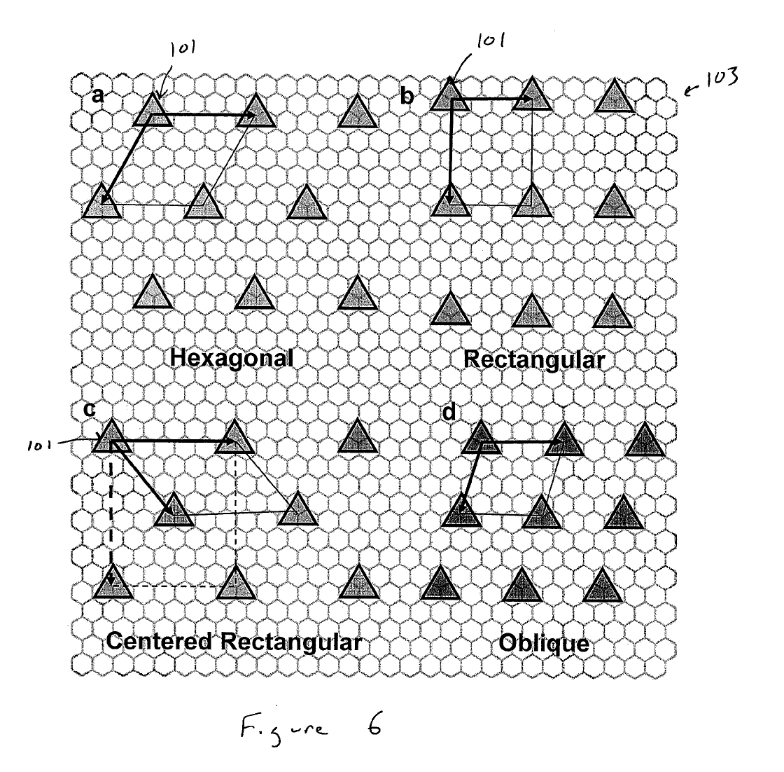

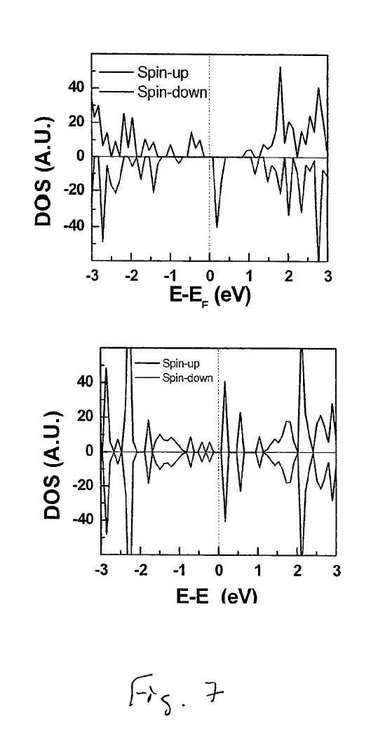

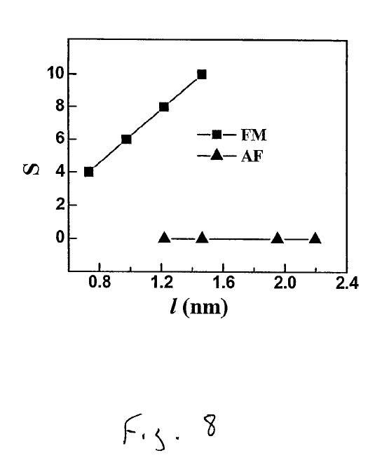

The triangular NHs have a metastable ferrimagnetic state with two edges having one spin and the other edge having the opposite spin (e.g. as shown in FIG. 5). For a 4-atom NH, the FM state is 52 meV lower in energy than the ferrimagnetic state, and the latter is 13 meV lower than the PM state. For a 32-atom rhombus NH, the AF state is 89.2 meV lower than the PM state; for a 54-atom hexagonal NH, the AF state is 164.4 meV lower than the PM state. The energy difference increases with increasing NH size. The triangular NHs favor FM at all sizes, whereas rhombus and hexagonal NHs only become AF when the edge has more than five atoms, i.e. they are PM if the NH is too small. So, the triangular NHs have a stronger tendency toward magnetization.

The magnetic ordering within a single NH is consistent with both the theorem of itinerant magnetism in a bipartite lattice and the topological frustration model of the n-bonds counting the unpaired spins in the nonbonding states. The honeycomb (i.e. open hexagonal) array of a graphene sheet may be considered to be composed of two sublattices of carbon atoms. For such a system consisting of two atomic sublattices, each sublattice assumes one spin and the total spin S of the ground state equals ½|N_{B}−N_{A}| where N_{B} (N_{A}) is the number of atoms on B (A) sublattice. Because of the honeycomb lattice symmetry, atoms on the same zigzag edge belong to the same sublattice; while atoms on two different zigzag edges belong to the same sublattice if the two edges are at an angle of 0° or 60°, but different sublattices if at an angle of 120° or 180°. Consequently, the triangular NH are FM, because all edges are on the same sublattice; the rhombus and hexagonal NHs are AF, because one-half the edges are on the A-sublattice and another half on the B-sublattice. Note, this same argument can be applied to nanoribbons and nanoflakes.

Next, consider GNH superlattices (a periodic array of NHs in graphene) by examining the inter-NH spin-spin interaction. Referring to FIG. 6, one can generate four out of five possible 2D Bravais lattices of NHs 101 in a graphene sheet 103.

Referring to FIG. 2, in embodiments featuring honeycomb superlattices 201 of triangular NHs (FIGS. 2a and 2b), each NH possesses a net moment acting effectively as “one” spin. The superlattice contains two sublattices of NHs, superimposed on the background of graphene containing two sublattices of atoms. NHs on the same sublattice are FM-coupled because their corresponding edges are at 0° to each other so that their edge atoms are on the same atomic sublattice. On the other hand, the NHs on different sublattices are FM-coupled if they are in a parallel configuration (FIG. 2a) but AF-coupled if they are in an antiparallel configuration (FIG. 2b) when their corresponding edges are at 180° to each other so that their edge atoms are on different atomic sublattices. This behavior has been confirmed by our first-principles calculations.

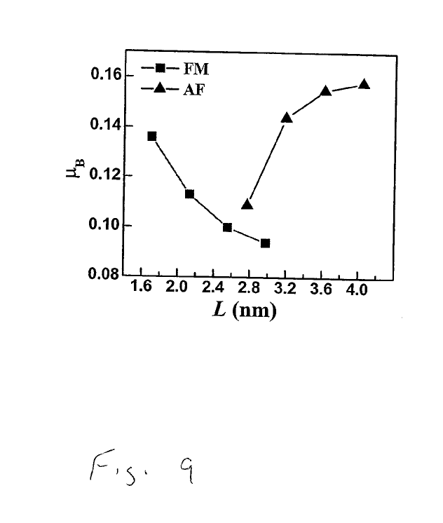

Independent of NH size and supercell dimension, the FM state is favored for parallel configurations but the AF state is favored for antiparallel configurations. In both cases, the spin-polarization splits the edge states opening a gap at the Fermi energy (illustrated in FIG. 7). The total spin S in one unit cell equals to ½|N_{B}−N_{A}|. It increases linearly in the FM parallel configuration but remains zero in the AF antiparallel configuration with increasing NH size (illustrated in FIG. 8).

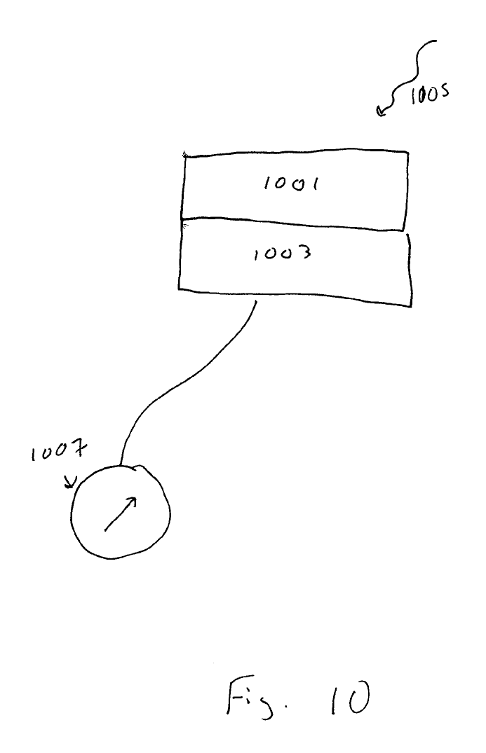

The collective magnetic behavior of a GNH superlattice depends on inter-NH spin-spin interaction. There exists super exchange interaction between the NH spins, in addition to the spin coupling defined by the underlying bipartite lattice. In FIG. 2c, we plot ΔE_{pc}=E(FM)−E(PM) for the FM parallel configuration and ΔE_{ac}=E(AF)−E(PM) for the AF antiparallel configuration as a function of cell dimension (L), i.e., the NH-NH separation. |ΔE_{pc}| increases while |ΔE_{ac}| decreases with decreasing L. This indicates that as the NHs move closer to each other, the FM state becomes relatively more stable, i.e. the FM coupling is favored by the super exchange interaction. Also, the edge magnetic moments are found to increase in the FM but decrease in the AF configuration with decreasing L (FIG. 9), reflecting that the edge magnetization on the neighboring NHs is enhanced with the same spin but suppressed with the opposite spin by the super exchange interaction.

The above results show that long-range ferromagnetic ordering can be created by employing the parallel configuration of triangular NHs in different lattice symmetries (e.g. as shown in FIG. 6). Again, while not intending to be bound by theory, the Curie temperature (T_{c}), below which long-range magnetic ordering occurs, has been estimated using the mean-field theory of Heisenberg model,

$${T}_{c} = \frac{2 Δ}{3 {k}_{B}} , \qquad ( 1 )$$

Where Δ is the energy cost to flip one “NH spin” in the FM lattice, which have been calculated directly from first principles for the honeycomb lattices (e.g. as shown in FIG. 2a). For example, FIG. 2d shows that T_{c} increases from 169 K to 1388 K when NH size (l) increases from 0.738 to 1.476 nm with cell dimension (L) fixed at 2.982 nm, and decreases from 586 K to 169 K when L increases from 1.704 nm to 2.982 nm with l fixed at 0.738 nm. These trends are expected since magnetization is stronger for larger NH size and higher NH density. Calculations confirm that FM GNH superlattices may be produced with T_{c} above room temperature by using a NH size of ˜50 nm and a density of 10⁻⁴ nm⁻², achievable by today's lithographic patterning technology.

We note that a recent experiment²⁵ has shown a T_{C}≦350 K in FM graphite made by proton bombardment.

In various embodiments, graphene-based nanostructures may be used in electronics applications. For example, in some embodiments, GNH magnetism provides for combining magnetic and semiconducting behavior in one material system. For example, diluted magnetic semiconductors (DMS) may be produced by exploiting GNHs with two different kinds of edges. Similar to superlattices of zigzag edge NHs, superlattices of NHs with edges in the “armchair” configuration. may be produced which constitute a class of 2D semiconductors. Referring to FIG. 3a, the armchair edge configuration is formed as shown in the edges of NHs 301 the honeycomb array of the carbon atoms of the graphene sheet 103.

FIG. 3b shows the semiconductor band structure of a superlattice of rhombus armchair NHs (as shown in FIG. 3a) having a direct band gap of 0.43 eV, as obtained from first-principles calculations. FIG. 3c shows the band gap as a function of NH size (l) and cell dimension (L), from tight-binding calculations. The gap increases with increasing 1 but decreases with increasing L.

In some embodiments, e.g. as shown in FIG. 3d a DMS can be made by adding triangular zigzag NHs 301 into a semiconductor superlattice of armchair NHs 301. In the embodiment shown, to provide the ferromagnetism the triangular NHs 303 are arranged parallel with each other acting like magnetic dopants.

Prior art DMS materials are synthesized by mixing two different materials, typically III-V semiconductors and transition-metal magnetic elements. The main challenge is to increase the magnetic dopant concentration in order to raise the Curie temperature (or Neel temperature in the case of antiferromagnetism, or critical temperature, generally), because the two types of materials are usually not miscible. In contrast, the material described herein is an “all-carbon” DMS (i.e. composed of an array of carbon atoms, with, for example, hydrogen bonds located only on the edges of superimposed NHs) in which combined semiconductor and magnetic behavior are achieved by structural manipulation. Consequently, room-temperature DMS are reachable because the dopant concentration can be increased without the miscibility problem. In alternative embodiments, other magnetic elements may be doped into the semiconducting GNH superlattice.

In various embodiments, engineered magnetic materials with NHs may be employed for various applications. For example, referring to FIG. 4 it is possible to directly pattern NHs into engineered magnetic storage media. These NHs may serve essentially the same function as magnetic domains found in conventional magnetic storage material, with the magnetic state of each NH encoding a piece of information. The NHs may be addressed and manipulated using any suitable techniques, e.g. those known in the field of magnetic storage media.

For example, as noted above, the ground state of a rhombus zigzag NH is AF (FIG. 1b and FIG. 4, lower-left inset) and its first excited state is FM (FIG. 4, up-right inset) when the NH size is larger than 14.6 Å. Taking each of an array of such NHs as one bit, we can assign the ground state with “S=0” and the excited state with “S=N” to represent the ‘0’ and ‘1’, respectively. The switching between ‘0’ to ‘1’ can be done by applying a local magnetic field or energy pulse to convert between the ground and the excited state. Using a NH size of ˜50 nm and a density of 10⁻⁴ nm⁻², a storage density about 0.1 terabit per square inch is achievable, much higher than the current density in use.

Note that, in typical embodiments, the magnetocrystalline anisotropy around individual NHs should be larger than k_{B}T for the proposed storage media to work (where T is the operating temperature). However, this limitation can be easily satisfied at room temperature for the examples given above, and for many other practical systems.

As noted above, NH lattice semiconductor material may be provided, e.g., using an array of armchair rhombus NHs. The semiconductor band gap for such material depends on the structural features of the NH lattice (e.g., NH size, NH shape, NH lattice density, etc.). Accordingly, the bandgap can be “tuned” to a desired size by a suitable choice of structural features. For example, NH superlattice semiconductor material may be constructed using currently available techniques with bandgaps of a few meV to a few tens of meV. Few natural materials are available with bandgaps in this energy range, which corresponds to the photon energy of electromagnetic radiation in the far infrared and terahertz range. It is therefore difficult and/or costly to produce semiconductor devices which efficiently emit or detect radiation in this frequency range.

In various embodiments, a NH superlattice semiconductor material having a bandgap tuned to this range may be incorporated into emitter and/or detector devices using techniques known in the art to provide emitters and/or detectors operable in the terahertz and/or far infrared (or other desired range). For example, Referring to FIG. 10, a graphene sheet 1001 containing a tuned bandgap semiconductor NH superlattice (not shown) may be chemically bonded to a further material 1003. Radiation 1005 incident on the NH superlattice with a frequency at or near the tuned band gap of sheet 1001 would excite the superlattice, resulting in changes of the chemical properties of the bonded material. Radiation at or near the bandgap is thereby detected by monitoring the chemical properties of the bonded material with monitor 1007. In general, in various embodiments, radiation at or near the bandgap can be detected by monitoring for changes in, for example, the electrical, chemical, mechanical, optical, or other properties of the NH lattice and/or materials interacting with the NH lattice. In some embodiments, the NH semiconductor materials may also include a magnetic NH superlattice as described above. The structure of the magnetic NH lattice can be chosen to additionally allow tuning of the magnetic properties of the material (e.g. the critical temperature for long-range magnetic ordering).

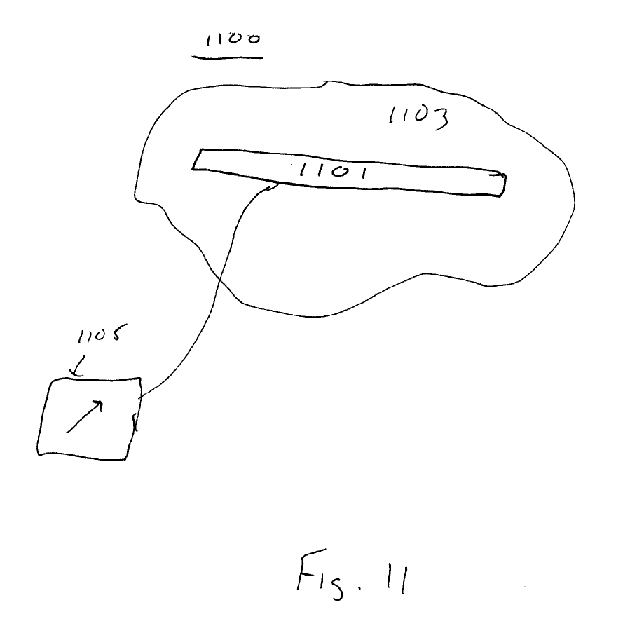

Referring to FIG. 11, sensor 1100 includes a graphene sheet 1100 including a NH array of one or more of the types described herein. The nanohole array interacts with chemical environment 1103. Monitor 1105 detects changes in the chemical environment based on changes on one or more physical properties of sheet 1101 (or one or more materials bonded to or otherwise interacting therewith). For example, in some embodiments monitor 1105 may measure transport changes in response to adsorption of molecules in chemical environment 1103 by the NH array of sheet 1101.

First-principles calculations for the simulations and examples described above were performed using the pseudopotential plane-wave method within the spin-polarized generalized gradient approximation as implemented in the Vienna Ab-initio Simulation Package (VASP) code³° known in the art. We used a rhombus supercell in the graphene plane with the cell size ranging from 14×14 Å to 41×41 Å and a vacuum layer of ˜10 Å. We used a 2×2×1 k-point mesh for Brillouin zone sampling and a plane wave cutoff of 22.1 Rd. The systems contain up to a maximum of 530 atoms. All the carbon atoms on the edge with dangling bonds are terminated by hydrogen atoms. The system is relaxed until the force on each atom is minimized to less than 0.01 eV/Å.

For calculating Curie temperatures, we used larger cells containing up to eight NH spins, and we found the results are not very sensitive to cell size, suggesting the nearest-neighbor NH-NH interactions dominate.

Tight-binding band structure calculations for semiconductor armchair GNH superlattices were performed using the nearest-neighbor n-band model with the hopping parameter γ=3.0 eV.

Note that while the illustrations above describe NH lattices embedded in a graphene sheet, any of the materials above may be formed in other suitable materials. In various embodiments, NH superlattices of the types described above may be formed in one or more or layers (e.g. a surface layer) of bulk graphite. In the case where the nanoholes extend through multiple layers, they may be referred to as nanochannels.

For example, highly oriented pyrolytic graphite (HOPG) is made up of alternating, nearly defect free graphene planes exhibiting honeycomb array structures directly analogous to that found in the graphene sheets described above. NH or nanochannel arrays may be patterned in one or more of these layers to produce any of the materials, structures, or devices described above.

For example, while not wishing to be bound by theory, first principles calculations indicate that many of the zigzag edge-induced magnetic properties in GBNs exist also in nanopatterned graphite films (NPGFs). Because graphite film is readily available, we propose that for certain applications the NPGFs may be used as a better candidate of magnetic nanomaterials than the GBNs to circumvent the difficulties associated with graphene synthesis.

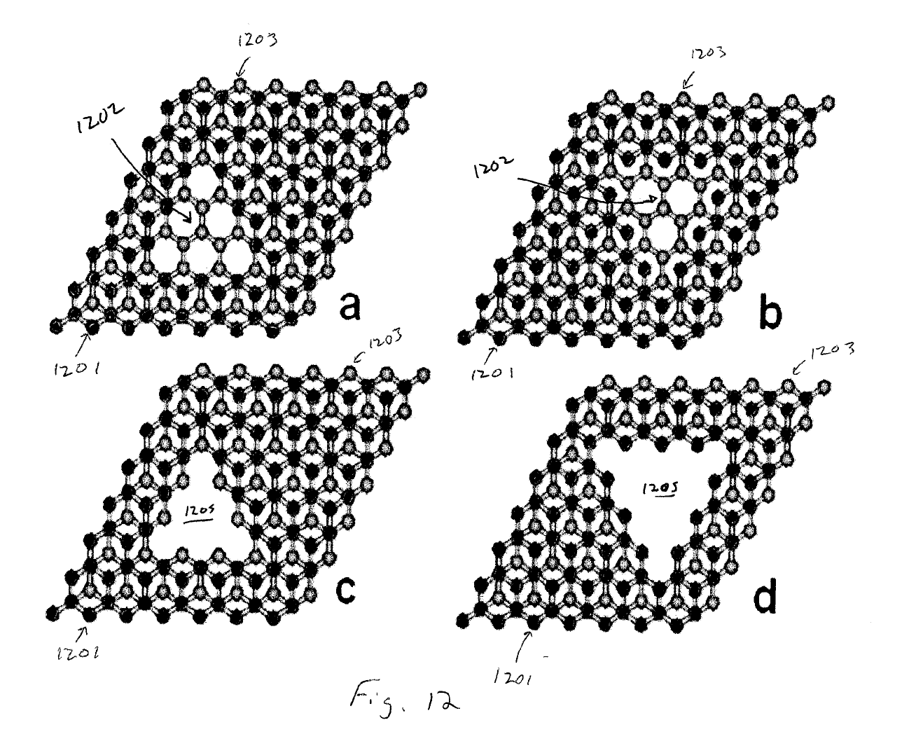

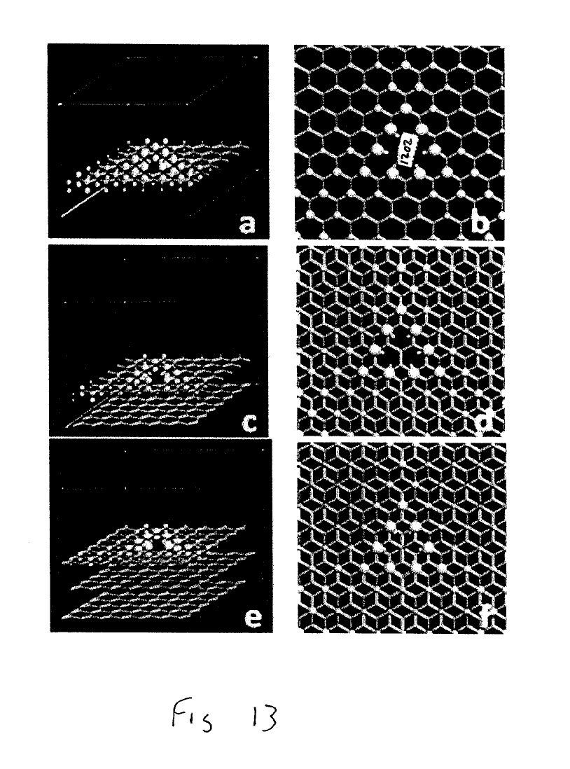

To illustrate our point, we consider two limiting cases of NPGFs: one with only the top atomic layer 1201 patterned with nanoholes 1202 like a GBN supported on a graphite substrate represented by underlying layer 1203 (as shown in FIGS. 12a & 12b), and the other with all the atomic layers 1201, 1203 in the graphite film patterned throughout like a nanochannel 1205 in graphite film (as shown in FIGS. 12c & 12d). As an example, we focus on studying the magnetic properties of triangular nanoholes with zigzag edges. In both cases, we found such nanoholes in graphite film exhibit a FM ground state having a very similar behavior as those in graphene.

For the triangular nanoholes supported on the graphite substrate, we consider two atomic configurations: one is a up-triangle as shown in FIG. 12a where each edge atom of nanohole 1202 sits on top of an atom in the second layer 1203, the other one is a down-triangle as shown in FIG. 12b where each edge atom of nanohole 1202 sits above the center of the hexagon in the second layer. For triangular nanochannels 1205 going through the whole graphite film, to maintain the zigzag edges of nanohole in each layer, the size of nanohole in one layer 1201 must be different from that in the underlying layer (i.e. the graphite film has a ABAB . . . two-layer stacking). FIG. 1c shows an example of up-triangular channel 1205 in which the top layer (let's A layer) has a 9-atom hole (removing 9 atoms) and the bottom B-layer has a 4-atom hole. FIG. 1d shows an example of down-triangular channel 1205 in which the top A-layer has a 9-atom hole and the bottom B-layer has a 16-atom hole. Note, however, the up-triangular nanochannel 1205 in FIG. 1c and the down-triangular nanochannel 1205 in FIG. 1d are actually the same channel structure of different size if one switches the A layer with the B layer (i.e reverses the vertical order of layers 1201 and 1203).

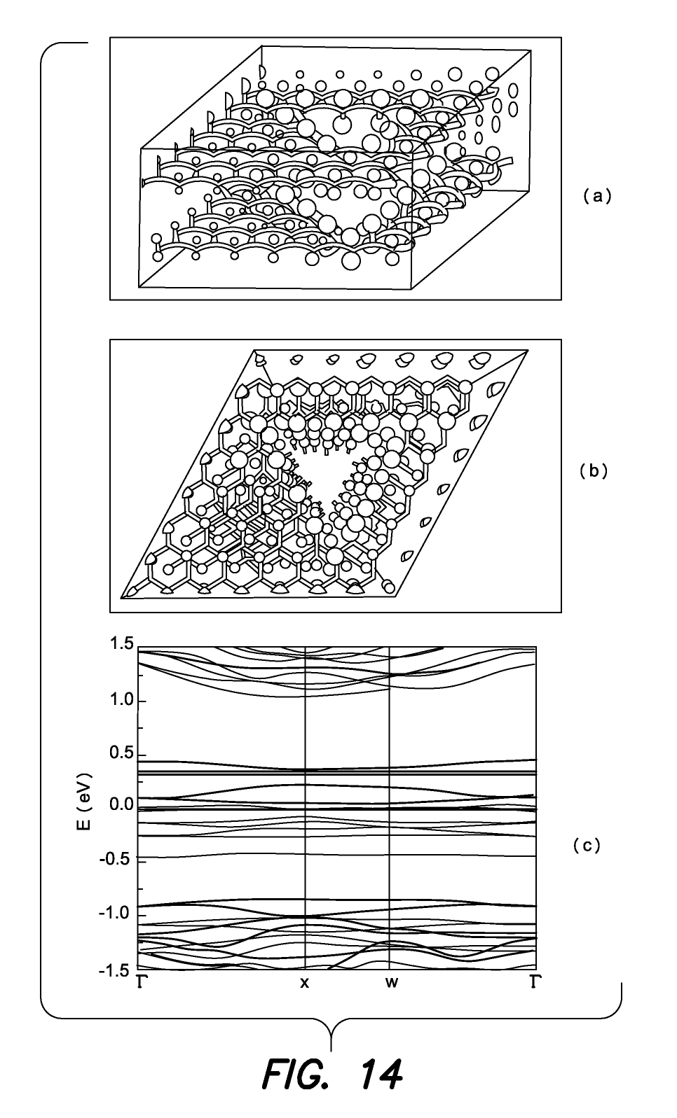

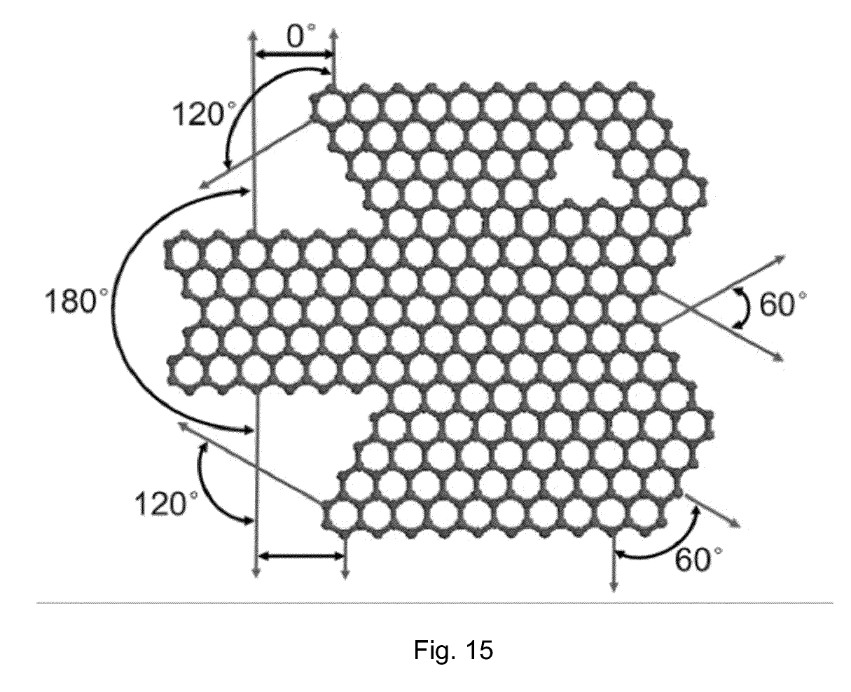

The above described NPGF first principles calculations were performed using the pseudopotential plane-wave method within the spin-polarized generalized gradient approximation. To model the supported nanoholes 1202, we used supercells consisting of one and two layers of substrate film plus a vacuum layer of 11.13 Å (see FIG. 13); to model the nanochannels 1205, we used supercells consisting of periodic stacking of AB layers as in graphite film (see FIG. 14). For both cases, we varied the nanohole size from 4- to 16-atom hole in two different sizes of rhombus supercells with a basal plane of 7a×7a (FIGS. 1) and 9a×9a, where a is the graphite lattice constant. We used the theoretically determined lattice constant a=2.46 Å and interlayer spacing of 3.35 Å. The largest system contains up to 324 atoms. We used a plane wave cutoff of 22.1 Rd. All the edge atoms are saturated with H and the atomic structure is optimized until forces on all atoms are converged to less than 0.01 eV/Å. For Brillouin zone sampling, we used a 2×2×1 k-point mesh for the case of supported nanoholes and a 2×2×4 mesh for nanochannels, respectively.

Triangular nanoholes were chosen because it is known such nanoholes have a ferromagnetic (FM) ground state in graphene, as shown in FIGS. 13a and 13b. According to the simple geometric designing rule, any two zigzag edges in graphene are FM-coupled if they are at a formal angle of 0° or 120° and AF-coupled if at an angle of 60° or 180°. Since the three edges in the triangular nanohole are at 120° to each other, they must belong to the same sublattice (A or B) and hence are FM-coupled in consistent with the itinerant magnetism model in a bipartite lattice.

The supported triangular nanoholes 1202 have essentially the same behavior, as shown in FIGS. 13c-13f. They all have a FM ground-state. For the supported 4-atom triangular nanohole in FIG. 13c, the FM sate is found to be ˜17.8 meV lower than the PM state. In fact, the ground-state magnetic configurations of the supported nanoholes are almost identical to those of the corresponding nanoholes in free graphene sheet, as one compares FIGS. 13c and 13e to FIG. 13a, and FIGS. 13d and 13f to FIG. 13b. The magnetic moments are largely localized on the edge atoms and decay exponentially moving away from the edge. The calculated total magnetic moment within one unit cell is also found equal to N_{B}−N_{A} as predicted from the itinerant magnetism model in bipartite lattice [15], where N_{B} (N_{A}) is the number of atoms on the B-sublattice (A-sublattice) within one unit cell. Consequently, the moment increases with the increasing nanohole size.

The above results indicate that, in some embodiments, the underlying substrate (graphite film) has a negligible effect on the magnetism of nanoholes in the top “graphene” layer. The magnetism is originated from the localized edge state from the broken sp2 type of bonding in the top graphene layer. The edge state is not expected to be affected much by the underlying graphite layer as there exists no strong interlayer “chemical” bonding except weak Van de Waals interaction between the top layer and underneath film. For the same reason the magnetic behavior of supported up-triangles are identical with that of down triangles although their edge atoms have a different atomic configuration in relation to the layer below (FIG. 12a vs. 12b).

Also, the above results suggest that despite the fact that the electronic structure of graphene is distinctly different from that of graphite film, such as the band structure, the structural defect-originated (or edge-originated) magnetic structure in graphene can be very similar (in the above case almost identical) to that of graphite film. These findings indicate that one may use NPGFs for creating the similar nanomagnetic structures to those produces with NH arrars formed in graphene sheets. For example, graphene nanohole superlattices described above for use as magnetic storage media. One may pattern such nanohole superlattices in the top layer of a graphite film without the need of going through the synthetic process of generating graphene.

In some embodiments, more than one layer of graphite film will be patterned through at the same time, forming nanochannels 1205. We have calculated the magnetic properties of nanochannels 1205 (for the calculation, taken to be an “infinite” number of stacked nanoholes) in a graphite film, as shown in FIG. 14. This “infinite” case represents the other limiting case opposite to the case of one layer of nanohole supported on the graphite film (e.g. as shown in FIG. 13).

Again, we found all the triangular nanochannels have a FM ground state, as illustrated by the ground-sate spin-density plots of a nanochannel in FIGS. 14a and 14b. For this particular nanochannel, the FM state is calculated to be ˜24 mev/unit cell lower than the AF state and ˜56.3 mev/unit cell lower than the PM state. The overall magnetic behavior of individual nanoholes in the nanochannel is similar to that of nanoholes in a single graphene layer (either free or supported). The magnetic moments are mostly localized at the edge and decay away from the edge. The total moments increase with the increasing nanochannel size or nanohole size in each layer for the fixed cell size, and decrease with the increasing cell size or decreasing nanochannel density for the fixed nanochannel size.

However, quantitatively we found in a nanochannel the total moments around a nanohole in each layer of graphite film no longer equals to N_{B}−N_{A} within the layer. This indicates there exist some magnetic interaction between the moments in the different layers, although the nature of this interaction is not clear. From the practical point of view, such quantitative variation is not that important as long as the FM ground state is retained in the nanochannel so that desirable magnetic nanostructures, such as nanohole superlattices can be created by nanopatterning of graphite films even though multiple layers of patterned films are involved.

FIG. 14c shows the band structure of the nanochannel 1205 of FIG. 14a. One interesting point is that, in this case, the “infinite” nanochannel 1205 is metallic, which is distinctly different from that of a nanohole in graphene which is a semiconductor. The band gap opening in a graphene nanohole is caused by spin polarization which makes the on-site energy of the spin-up A-edge state differ from that of the spin-down B-edge state. In a nanochannel, the interlayer interaction broadens the distribution of the on-site energies of A- and B-edges making the spin-up A edge states (bands) overlap with the spin-down B-edge bands, closing up the band gap.

Several experiments have observed magnetism in nanographite-based fiber, all-carbon nanofoam, and proton irradiated graphite. It is believed that the magnetism in these nanostructures is originated from the intrinsic properties of carbon materials rather than from the magnetic impurities. The edge magnetism discussed herein describes an origin of various (possibly all) types of carbon-based nanomagnetism.

The above demonstrates that graphite films can become an all-carbon intrinsic magnetic material when nanopatterned with zigzag edges, using first-principles calculations. The magnetism in NPGFs may be localized within one patterned layer or extended throughout all the patterned layers. It is originated from the highly localized edge states in analogy to that in GBNs. Because graphite film is readily available for mass production, for some applications the NPGFs can be superior for many applications that have been proposed for GBNs.

The NH lattice structures described above can be produced using any suitable fabrication know in the art. For example, a graphene sheet (or HOPG layer, etc.) may be patterned with one or more NH arrays using conventional photolithography techniques. As is well known in the art, a photolithographically patterned mask is formed on the sheet, exposing only the areas where NHs are desired. The NHs are then formed by, for example, particle (electron, proton, ion, etc) bombardment, chemical processes such as etching, etc. The mask layer is then removed, leaving behind the graphene sheet (or graphite fil,), now containing one or more NH or nanochannel lattices. NHs or nanochannels having sizes ranging as small as about 50 nm or less and arranged in lattices having a density of about 10⁻⁴ nm⁻² or greater can be produced using such techniques.

### Magnetic Nanostructures

Not intending to be bound by theory, the inventors have realized that, based on the underlying graphene lattice symmetry and an itinerant magnetism model on a bipartite lattice, a unified geometric rule may be developed for designing graphene-based magnetic nanostructures: spins are parallel (ferromagnetic (FM)) on all zigzag edges which are at angles of 0° and 120° to each other, and antiparallel (antiferromagnetic (AF)) at angles of 60° and 180°. Applying the rule, one can predict several graphene-based magnetic nanostructures: 0-D FM nanodots with increased or even the highest possible magnetic moments, 1-D FM nanoribbons, and 2-D magnetic superlattices (as described in greater detail above).

The electronic properties of crystalline structures may be closely related to their underlying lattice symmetries. In some situations, the complex electronic properties of the structures mage often governed by simple geometric rules. One example is the relationship between the electronic properties of carbon nanotubes (CNTs) and their chirality. Using (m, n) to denote the chirality, a CNT is metallic if (m n) is divisible by 3 and semiconducting otherwise. This rule is very useful in understanding the electronic properties of CNTs. Similar rules have been discussed for graphene nanoribbons with modifications in respect to their edge states.

Various graphene-based nanostructures (GBNs), such as graphene nanoribbons, nanodots, and nanoholes, with zigzag edges may exhibit magnetism, making them a class of organic nanomagnets. The magnetization in GBNs originates from the localized edge states [that give rise to a high density of states at the Fermi level, rendering a spin-polarization instability. However, the energies of different magnetic phases (e.g., ferromagnetic (FM) vs antiferromagnetic (AF)) of a GBN can typically only be determined as after-math post priori first principles calculations. Either the FM or AF phase may be the ground state depending on the underlying GBN symmetries. In some applications, It would be advantageous to have a unified guiding principle in designing possible magnetic nanostructures in graphene. Herein is described a generic geometric rule that underlies the magnetic ordering of GBNs.

The ground state magnetic ordering within a single nanoribbon, nanodot or nanohole [15] may be consistent with the theorem of itinerant magnetism in a bipartite lattice within the one-orbital Hubbard model. As described in detail above, graphene consists of two atomic sublattices (A and B), and a zigzag edge must be either on an A- or B-lattice. It is found that in a given GBN, two edges will be FM-coupled if they are on the same sublattice and AF-coupled if they are not. The total spin S of the ground state equals ½|NB−NA|, where NB(NA) is the number of atoms on the B(A) sublattice. This indicates that there exist a set of rules to define the condition of magnetism in graphene. Furthermore, by examining the grapheme lattice symmetry, one may formulate a generic “geometric” rule that dictates the edge types in a GBN for its given symmetry, so as to define its magnetic order. Applying this geometric rule, an exemplary series of magnetic GBNs have been designed as described herein whose rule-defined ground states are further confirmed by first principles calculations.

The basic principle of the geometric rule is illustrated in FIG. 15. Because of the underlying honeycomb lattice symmetry, the relationship between any two zigzag edges is uniquely defined by their relative angle to each other. Specifically, atoms on the same zigzag edge belong to the same sublattice (either A-lattice (light grey)) or B-lattice (dark grey)); atoms on two different zigzag edges belong to the same sublattice if the two edges are at an angle of 0° or 120° to each other, but different sublattices if at an angle of 60° or 180° to each other. To avoid confusion, the angle between any two edges is defined formally as the angle between the two normal vectors of the edges. Then, an exemplary unified design rule states: two zigzag edges are FM-coupled if they are at an angle of 0° or 120° and AF-coupled if at an angle of 60° or 180°. The rule partially reflects the three-fold rotational symmetry of the graphene honeycomb lattice and the reflection symmetry between the two sublattices. As described herein this rule can be applied in designing at least three different classes of magnetic GBNs: the 0-D nanodots, 1-D nanoribbons, and 2-D nanohole superlattices.

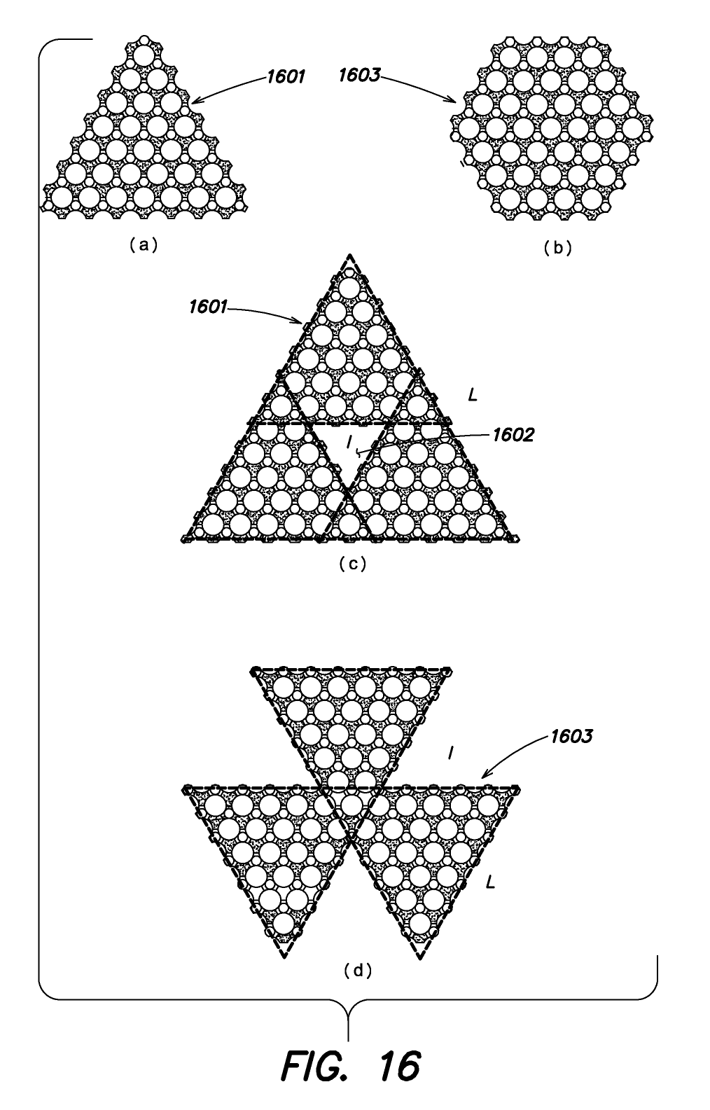

For example, one may cut the graphene into small 0-D nanodots bounded by zigzag edges, as shown in FIG. 16. According to the rule, a triangular dot is FM (FIG. 16(a)), because all three edges are at 120° to each other; a hexagonal (also true for a rhombus shaped) dot is AF, because any two neighboring edges are at 60° to each other. The magnetic order is graphically shown in FIG. 16 with the color coding of the edge, i.e. the light grey A-edge (spin up) vs the dark grey B-edge (spin down). The same color coding will be used in the following discussion. Note that color versions of FIGS. 15-18 are reproduced as FIGS. 1-4 in D. Yu, E. M. Lupton, H. Gao, C. Zhang, F. Liu, A Unified Geometric Rule for Designing Nanomagnetism in Graphene NANO RESEARCH 1 497 (2008) the entire contents of which are incorporated by reference herein. In the grayscale images presented herein, dark grey corresponds to blue as shown in the above referenced color figures, while light grey corresponds to red.

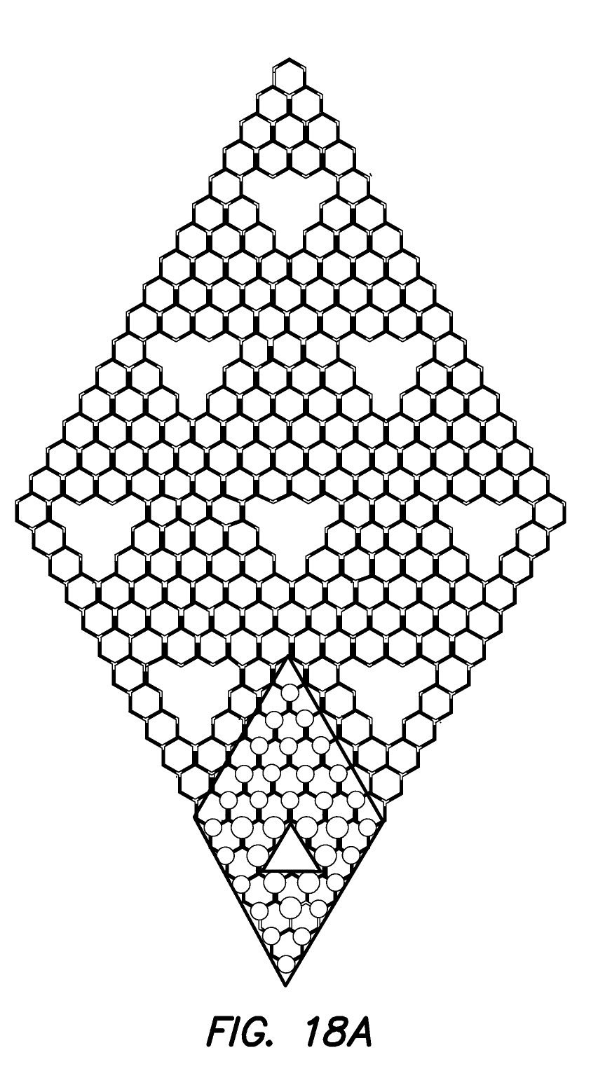

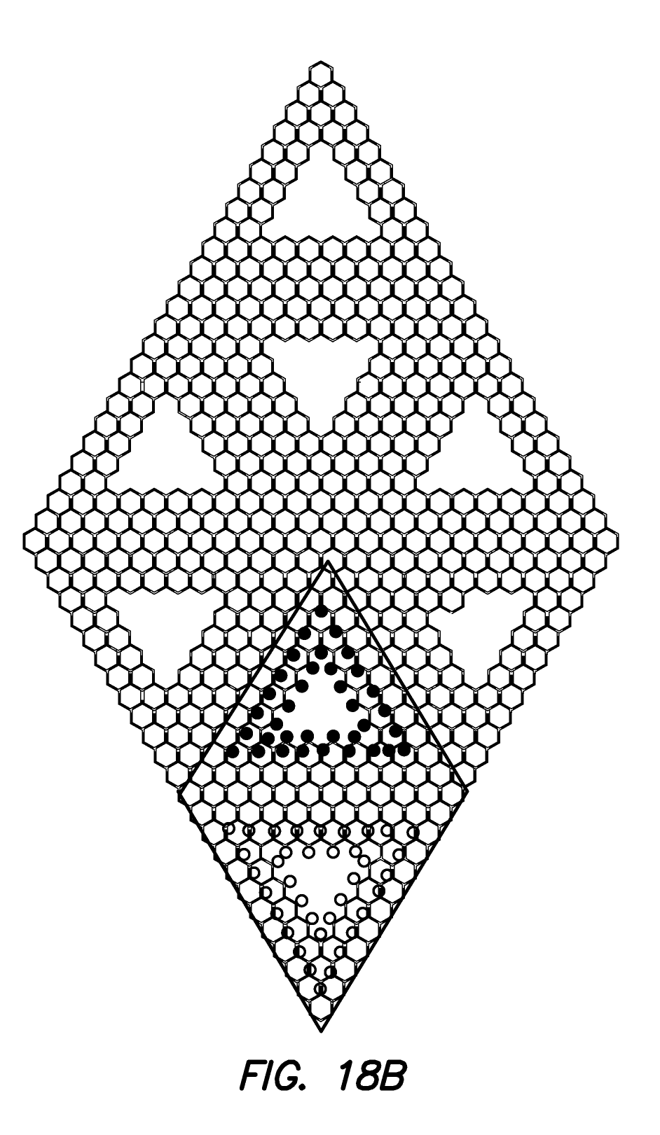

The magnetic ground states of the nanodots predicted by this simple rule are found to be consistent with the existing first principles calculations of all different shapes of nanodots. Also, the same is true for individual nanoholes (antidots) punched in graphene (see FIG. 18 and related discussion below).

Only FM nanodots have a net magnetic moment, while AF nanodots typically have substantially zero moment. For typical magnetic and spintronic applications, it is desirable to search for FM nanodots with a high net moment (e.g., as high as possible). This search would be rather difficult with time consuming first principles calculations. With the aid of a generic design rule, such searches become much easier. As the rule suggests, one design concept is to eliminate edges which are at 60° or 180° to each other, so that the nanodots contain only edges which are at 0° or 120° to each other and they all have the same spin orientation. A second design concept is to elongate the edge length as much as possible to increase or maximize the total net moment.

FIGS. 16(c) and 16(d) illustrate two elemental designs which fulfill these two key requirements. The FM nanodot in FIG. 16(c) is derived from the triangular structure 1601 of FIG. 16(a) by punching a small down-triangle 1602 inside a larger uptriangle 1601 (or conversely a small up-triangle inside a larger down-triangle) to make all edge B-type (dark grey). The FM nanodot in FIG. 16(d) is derived from the hexagonal structure 1603 shown FIG. 16(b) by cutting each of three B-type edges (dark grey) in the hexagon 1603 into two A-type edges (light grey) (or conversely cutting three A-type into six B-type), so that all the edges are of A-type.

In some embodiments, FM nanodots with high (e.g., maximized) moments may be formed by stacking many triangular FM dots together. Then, as indicated by the dashed-line triangles, one can view the configuration shown in FIG. 16(c) as one way of stacking triangular dots together by sharing their edges, and FIG. 16(d) as another way of stacking triangular dots together by sharing their corners. By exploiting these two design elements, FM nanodots with large (i.e., the largest possible) total magnetic moments can be created.

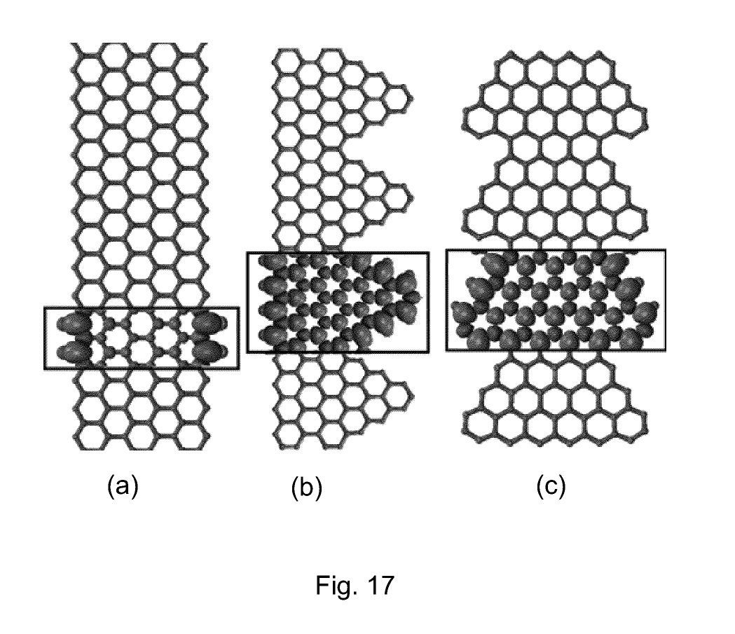

FIG. 17 illustrates the design of 1-D nanoribbons. A simplest ribbon structure is one with two straight edges. According to the rule, the two edges are AF coupled because they are at 180° to each other (as shown in FIG. 17(a)), which is may be confirmed by first principles calculations. Also, the sawtooth-like ribbons with parallel edges are FM. The AF nanoribbons can be useful in their own right. For example, under a transverse electrical field, they behave as a semimetal. In other applications, FM nanoribbons may be desirable. Previously, researchers have proposed the idea of converting the AF nanoribbons into FM ones by extrinsic effects such as introducing defects and impurity atoms/molecules along one of the two edges. Here, by applying the geometric rule, intrinsic (pure carbon) FM nanoribbons may be designed by manipulating their edge geometries.

The technique is to change the relative orientations of the two edges so that they become at 0° or 120° to each other instead of at 180° as in the straight ribbons. FIGS. 17(b) and 17(c) show two such designs of FM ribbons. In FIG. 17(b), one straight edge of the ribbon is maintained while cutting the other edge into a sawtooth shape with 60° contact angle. As such, one makes a tree-saw shaped FM nanoribbon. In FIG. 17(c), both edges are cut into another kind of saw-tooth shape to make a Christmas-tree shaped FM nanoribbon. First principles calculations confirm that examples of such nanoribbons have an FM ground state. The calculations were performed using the pseudopotential plane-wave method within the spin-polarized generalized gradient approximation as before. The calculations used a rhombus supercell with a vacuum layer of ˜10 Å to separate the graphene planes and a plane wave cut-off of 22.1 Rd. All the carbon atoms on the edge with dangling bonds are terminated by hydrogen atoms. The system is relaxed until the force on each atom is minimized to less than 0.01 eV/Å.

The ground state spin densities within one unit cell of nanoribbon are plotted in FIG. 17 to illustrate their magnetic ordering (see density contours inside the rectangular unit cells). For the tree-saw nanoribbon in FIG. 17(b), the FM ground state is found to be 100 meV per unit cell lower than the AF state which is lower than the paramagnetic (PM) state by 220 meV. For the Christmas-tree nanoribbon in FIG. 17(c), the FM ground state is found to be 33 meV per unit cell lower than the PM state which is lower than the AF state by 8 meV. The total magnetic moment in the FM ground state is calculated to be 3.0 and 2.0 μB per unit cell for the tree-saw and Christmas-tree nanoribbon, respectively, which are equal to (NB-NA) as predicted from the itinerant magnetism model in a bipartite lattice.

Further, one may apply the design rule to provide 2-D magnetic GBNs, the graphene nanohole (NH) superlattices, as shown in FIG. 18, and as described in greater detail above. Suppose a periodic array of nano-sized holes with zigzag edges are punched in graphene. Each individual NH, which is essentially an inverse structure of a nanodot (anti-dot), has the same magnetic configuration as a nanodot. Then, according to the design concept, to construct a superlattice the triangular FM NH will be a possible choice with non-zero net moment, and can be viewed effectively as a “super magnetic atom” in the superlattice. To increase the moment of such super magnetic atoms, more complicated NH geometries like the inverse structures of FIGS. 16(c) and 16(d) can also be designed.

In designing a magnetic NH superlattice, the generic geometric rule can be applied not only to the intra-NH spin ordering within each NH, but also to the inter-NH spin ordering among different NHs. Two triangular NHs will be FM-coupled if their corresponding edges are at 0° and 120° to each other, but AF-coupled if their corresponding edges are at 60° and 180° to each other. Therefore, an overall FM superlattice can be designed using a periodic repeating unit cell containing one triangular NH as shown in FIG. 18(a), while an AF superlattice can be obtained by using a unit cell containing two anti-paralleled triangular NHs (one up- and one down-triangle) as shown in FIG. 18(b).

The ground state spin densities within one unit cell, as obtained from first principles calculations, are plotted in FIGS. 18(a) and 18(b) to confirm their respective FM and AF ordering as predicted by the rule. For FIG. 18(a), the FM ground state is found to be 61.3 meV per unit cell lower than the AF state which is lower than the paramagnetic (PM) state by 11.8 meV. For FIG. 18(b), the AF ground state is found to be 63.0 meV per unit cell lower than the FM state which is lower than the PM state by 23.7 meV. The calculated total magnetic moments for the FM (FIG. 18 (a)) and AF (FIG. 18(b)) ground states are 2.0 μB and 0.0 μB per unit cell, respectively, which are again equal to (NB-NA) as predicted from the itinerant magnetism model in a bipartite lattice.

In view of the successful application the above described geometric rules and design concenpts in designing nanomagnetic graphene for various dimensions as discussed above but not intending to be bound by theory, the following comments on the physical origin underlying the rule may apply in certain embodiments. The magnetic couplings may be attributed to two distinct mechanisms: one is the coupling of nonbonding states, which arises from topological constraints; the second is the magnetic instability of low energy states, which could be present when the size of the pattern is sufficiently large. For the first mechanism, size is not an issue and either FM or AF coupling could be possible for short zigzag edges that are only a couple of benzene rings long. The nature of the electron-electron interactions seem to dictate the FM coupling between the same non-bonding edges (A or B) and AF coupling between different edges (A vs B). However, when nonbonding states are not present and the size of the system is small, such as the hexagonal nanodot in FIG. 16(b), the edges will not be spin polarized and the geometric rule therefore does not hold. This is indeed confirmed by first principles calculations which showed a PM ground state for an exemplary structure featuring very small hexagonal nanoholes or two small triangular nanoholes of opposite orientation (see FIG. 18(b)) very close to each other.

In summary, set forth herein is a generically applicable geometric rule useful in typical applications for designing the magnetic ground state of GBNs bounded by zigzag edges, by unifying the underlying graphene lattice symmetry with an itinerant magnetism model on a bipartite lattice. The rule predicts that any two zigzag edges will be FM-coupled if they are at an angle of 0° or 120° and AF-coupled if at an angle of 60° or 180°. These principles have been applied to design an exemplary series of 0-D, 1-D and 2-D GBNs, and confirmed the predictions by first principles calculations for exemplary designs. In other embodiments, these geometric rules and design principles may be applied to any suitable application, such as the design of magnetic materials using nanopatterned graphite.

U.S. Provisional Application Ser. No. 61/069,213 filed on Mar. 13, 2008, and International Application PCT/US2009/037009, filed Mar. 12, 2009, contain material related to the current disclosure. The entire contents of each of these documents are incorporated by reference herein in their entirety.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

A computer employed to implement at least a portion of the functionality described herein may comprise a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to and/or receive communications from other devices. The display unit(s) may be provided, for example, to allow a user to view various information in connection with execution of the instructions. The user input device(s) may be provided, for example, to allow the user to make manual adjustments, make selections, enter data or various other information, and/or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

As used herein the term “light” and related terms (e.g. “optical”) are to be understood to include electromagnetic radiation both within and outside of the visible spectrum, including, for example, ultraviolet and infrared radiation.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A magnetic material comprising:
a graphene nanodot comprising a two dimensional bipartite lattice of carbon atoms comprising a first sublattice of carbon atoms having a first spin state and a second sublattice of carbon atoms having a second spin state.

2. The magnetic material of claim 1, wherein the graphene nanodot comprises a ferromagnetic nanodot, wherein the each of the edges of the nanodot are oriented at 0 or 120 degrees with respect to any neighboring edge, and wherein each edge carbon atom has the same spin state.

3. The magnetic material of claim 2, wherein the nanodot comprises a triangular nanodot.

4. The magnetic material of claim 2, wherein the ferromagnetic nanodot comprises N total atoms, is arranged in a maximally elongated structure available for a ferromagnetic nanodot having N atoms arranged such that each of the edges of the nanodot are oriented at 0 or 120 degrees with respect to any neighboring edge.

5. The magnetic material of claim 4, wherein the nanodot comprises three triangular portions sharing a common edge.

6. The magnetic material of claim 4, wherein the nanodot comprises three triangular portions sharing a common corner

7. The magnetic material of claim 1, wherein the graphene nanodot comprises an anti-ferromagnetic nanodot, wherein the each of the edges of the nanodot are oriented at 60 or 180 degrees with respect to any neighboring edge, and wherein each and every edge carbon atom has the same spin orientation.

8. The magnetic material of claim 7, wherein the nanodot comprises a hexagonal nanodot.

9. The magnetic material of claim 1, wherein said magnetic material has long-range magnetic ordering at a temperature below a critical temperature Tc.

10. The magnetic material of claim 9, wherein Tc is greater than 298° K.

11. The magnetic material of claim 1, wherein the two dimensional bipartite lattice of carbon atoms consist of a hexagonal array.

12. The magnetic material of claim 11, wherein the two dimensional bipartite lattice array of carbon atoms has edges having a zigzag configuration on the hexagonal array.

13. The magnetic material of claim 1, wherein the nanodot has characteristic size of about 50 nm or less.

15. The magnetic material of claim 1, wherein nanodot has a characteristic size of about 100 nm or less.

16. The magnetic material of claim 1, wherein the nanodot has characteristic size of about 500 nm or less.

17. The magnetic material of claim 1, wherein the nanodot has a characteristic size of about 1000 nm or less.

18. The magnetic material of claim 1, wherein the nanodot has a characteristic size of about 5000 nm or less.

19. The magnetic material of claim 10 wherein the long range ordering is ferromagnetic.

20. The magnetic material of claim 10 wherein the long range ordering is anti-ferromagnetic.

21. A magnetic material comprising:
a graphene nanoribbon comprising a two dimensional bipartite lattice of carbon atoms comprising a first sublattice of carbon atoms having a first spin state and a second sublattice of carbon atoms having a second spin state;
wherein the nanoribbon is elongated along a major dimension and extends between a first edge and a second edge along a minor dimension transverse the major dimension.

22. The magnetic material of claim 21, wherein
the nanoribbon comprises a ferromagnetic nanoribbon,
and the first edge is comprised of a plurality of edge portion, wherein each of the edge portions are oriented at 0 or 120 degrees with respect to any neighboring edge portion, and wherein each edge portion carbon atom has the same spin state.

23. The magnetic material of claim 22, wherein at least a portion of the first edge has a saw-toothed shape.

24. The magnetic material of claim 21, wherein
the second edge is comprised of a plurality of edge portion, wherein each of the edge portions of the second edge are oriented at 0 or 120 degrees with respect to any neighboring edge portion, and wherein each edge portion carbon atom has the same spin state.

25. The magnetic material of claim 24, wherein at least a portion of the second edge has a saw-toothed shape.

26. The magnetic material of claim 21, wherein said magnetic material has long-range magnetic ordering at a temperature below a critical temperature Tc.

27. The magnetic material of claim 26, wherein Tc is greater than 298° K.

28. The magnetic material of claim 21, wherein the two dimensional bipartite lattice of carbon atoms consist of a hexagonal array.

29. The magnetic material of claim 28, wherein the two dimensional bipartite lattice array of carbon atoms has edges having a zigzag configuration on the hexagonal array.

30. The magnetic material of claim 21, wherein the nanoribbon has characteristic size along the minor dimension of about 50 nm or less.

31. The magnetic material of claim 21, wherein nanoribbon has a characteristic size along the minor dimension of about 100 nm or less.

32. The magnetic material of claim 21, wherein the nanoribbon has characteristic size along the minor dimension of about 500 nm or less.

33. The magnetic material of claim 21, wherein the nanoribbon has a characteristic size along the minor dimension of about 1000 nm or less.

34. The magnetic material of claim 21, wherein the nanoribbon has a characteristic size along the minor dimension of about 5000 nm or less.

35. The magnetic material of claim 27 wherein the long range ordering is ferromagnetic.

36. The magnetic material of claim 27 wherein the long range ordering is anti-ferromagnetic.

37. The magnetic material of claim 36, wherein the magnetic material becomes a semimetal in the presence of an electrical field.
